(19) United States
(12) Patent Application Publication
(10) Pub. No.: US 2024/0081319 A1
(43) Pub. Date: Mar. 14, 2024

(54) ANIMAL LURE TREE WRAP

(71) Applicant: Kevin C. Maziarz, Conneaut Lake, PA (US)

(72) Inventor: Kevin C. Maziarz, Conneaut Lake, PA (US)

(21) Appl. No.: 18/465,737

(22) Filed: Sep. 12, 2023

Related U.S. Application Data
(60) Provisional application No. 63/405,736, filed on Sep. 12, 2022.

(51) Int. Cl. A01M 31/06; F16M 13/02

(52) U.S. Cl. CPC A01M 31/06; F16M 13/022

(57) ABSTRACT

A tree wrap for luring and hunting an antlered animal has an upper edge, a lower edge, a first side edge, a second side edge, a front side, and a back side. An upper camouflage member is disposed at the upper edge, on the front side of the tree wrap, and is configured for blending into a bark of a tree. A lower camouflage member is disposed at the lower edge, on the front side of the wrap, and is configured for blending into the bark. A mock rub member is disposed between the upper and the lower camouflage members, on the front side of the wrap, for simulating an antler rub created by an animal scraping an antler against the tree. A fastener is configured to attach the front side to the back side of the wrap such that the wrap is fastened around a tree.

### FIELD

This disclosure relates to a tree wrap for being installed over a tree and luring and hunting an antlered animal. More specifically, this disclosure relates to a tree wrap used as an animal lure during hunting of antlered animals.

### BACKGROUND

Antlered animals (e.g., deer, elk, moose, etc.) rub their antlers on trees and make an “antler rub,” or a “rub.” A rub removes the bark of the tree and splinters the inside of the tree, leaving distinctive marks on the side of the tree. Antlered animals can be attracted to a rub on a tree and approach the rub to investigate.

### SUMMARY

Embodiments described herein include a tree wrap for being installed over a tree for luring and hunting an antlered animal. Embodiments described herein include a method of using the tree wrap for luring and hunting an antlered animal. When attached to a tree, the tree wrap simulates a rub created on the tree by an antlered animal and attracts antlered animals.

In an embodiment, a tree wrap for being installed over a tree and luring and hunting an antlered animal is provided. A tree wrap may be set up at a desired hunting area to imitate a rub and help attract an antlered animal to the hunting area. As described below, the tree wrap can be easy to carry, and can have a fastener to quickly fasten the wrap onto a tree and quickly remove from the tree. The tree wrap may advantageously help reduce the weight carried/transported by a hunter, injury to the hunter, and injury to trees.

In an embodiment, the tree wrap comprises an upper edge, a lower edge opposite the upper edge, a first side edge, a second side edge opposite the first side edge, a front side, and a back side; an upper camouflage member disposed at the upper edge, on the front side of the tree wrap, and is configured for blending into a bark of a tree; a lower camouflage member disposed at the lower edge, on the front side of the tree wrap, for blending into the bark; a mock rub member disposed between the upper camouflage member and the lower camouflage member, on the front side of the tree wrap, for simulating an antler rub created by an animal scraping an antler against the tree; and a fastener configured to attach the front side of the wrap to the back side of the wrap such that the wrap is fastened around the tree.

In an embodiment, at least one of the upper camouflage member and the lower camouflage member has a pattern simulating a tree bark.

In an embodiment, at least one of the upper edge and the lower edge is frayed and has a jagged line for blending with texture of the bark.

In an embodiment, the upper camouflage member has a lower edge juxtaposed to the mock rub member, and the lower camouflage member has an upper edge juxtaposed to the mock rub member, and at least one of the lower edge of the upper camouflage member and the upper edge of the lower camouflage member has protrusions that extend into the mock rub member and recessions that recede from the mock rub member and create a jagged line.

In an embodiment, the fastener is positioned on the tree wrap so as to adjustably fasten the tree wrap onto the tree, with the back side of the tree wrap facing the tree.

In an embodiment, the tree wrap further comprises a scent holder disposed on the tree wrap and configured to hold a scent dispenser.

In an embodiment, the scent holder is a scent pouch member affixed to the tree wrap, wherein the scent pouch member is configured to hold the scent dispenser and diffuse scent.

In an embodiment, the scent holder includes a grommet disposed on the tree wrap for receiving a string or a ribbon for hanging the scent dispenser.

In an embodiment, the scent holder is disposed in at least one of the upper camouflage member and the lower camouflage member.

In an embodiment, the fastener is a hook-and-loop fastener.

In an embodiment, the fastener is a fastener of which noise of attaching and releasing the fastener is reduced.

In an embodiment, the wrap is made of a foldable material.

In an embodiment, the upper camouflage member, the lower camouflage member, and the mock rub member are made of fabric.

In an embodiment, the fabric is sweat resistant so that transfer of sweat and oil from user contact is reduced.

In an embodiment, the upper camouflage member, the lower camouflage member, and the mock rub member are separate pieces and are attached together.

In an embodiment, a method is for lure hunting an antlered animal using a tree wrap. The tree wrap includes: an upper edge, a lower edge opposite the upper edge, a first side edge, a second side edge opposite the first side edge, a front side, and a back side; an upper camouflage member disposed at the upper edge, on the front side of the tree wrap, and is configured for blending into a bark of a tree; a lower camouflage member disposed at the lower edge, on the front side of the tree wrap, for blending into the bark; a mock rub member disposed between the upper camouflage member and the lower camouflage member, on the front side of the tree wrap, for simulating an antler rub created by an animal scraping an antler against the tree; and a fastener configured to attach the back side of the wrap to the front side of the wrap such that the wrap is fastened around the tree. The method includes positioning a tree wrap against a tree at a suitable height for an antler rub, wrapping the tree wrap around the tree with a front side of the tree wrap facing outward, blending at least one of an upper camouflage member and the lower camouflage member with a bark of the tree; and fastening the tree wrap to the tree.

In an embodiment, the method further comprises applying a scent material to the tree wrap.

In an embodiment, the method further comprises loosening the fastener to remove the wrap from the tree.

In an embodiment, the fastener is affixed on the front side or the back side of the wrap, and the method further comprises fastening by pressing the fastener to the wrap.

### BRIEF DESCRIPTION OF THE DRAWINGS

FIG. 1A is a schematic front view of an embodiment of a tree wrap.

FIG. 1B is a schematic back view of an embodiment of the tree wrap.

FIG. 2A is a schematic front view of an embodiment of a tree wrap with a fastener.

FIG. 2B is a schematic front view of an embodiment of a tree wrap with a fastener.

FIG. 2C is a schematic front view of an embodiment of a tree wrap with a fastener.

FIG. 2D is a schematic front view of an embodiment of a tree wrap with a fastener.

FIG. 3 is a schematic front view of the tree wrap in FIG. 1A fastened on a tree, according to an embodiment.

FIG. 4 is a schematic back view of the tree wrap in FIG. 1A fastened onto a tree, according to an embodiment.

FIG. 5 is a schematic front view of a grommet of an embodiment of the tree wrap receiving a string holding a scent diffuser.

FIG. 6 is a block flow chart of an embodiment of a method for lure hunting an antlered animal.

Like reference numbers refer to like components throughout the drawings.

### DETAILED DESCRIPTION

This disclosure relates to a tree wrap for being installed over a tree and luring and hunting an antlered animal. More specifically, this disclosure relates to a tree wrap used as an animal lure during hunting of antlered animals. When attached to a tree, the tree wrap simulates a rub created on the tree by antlered animals and attracts antlered animals.

For lure hunting, a hunter may bring a decoy rub that is a piece of wood that has a scarring that resembles a deer rub and setting up in a hunting area. The hunter may create the decoy rub by scarring a tree with a knife. The hunter might also be marking the tree with a scent material (e.g., scent lure, scent liquid, etc.) to mimic a deer rub.

Using a decoy rub might include the hunter to carry the wood to the desired hunting site and set up the wood at the site. The process might be cumbersome, as wood is not easily portable. A decoy rub can be left at the installed site for an extended period of time, as it is not easy to quickly set up a decoy rub at a time and location the hunter wishes to hunt. In addition, carrying a heavy wood and tools and setting up a decoy rub is burdensome to the hunter and makes noise, which can repel animals.

The scarring trees with a knife to create a decoy rub can damage the tree and leave the tree susceptible to disease, and might be illegal in jurisdictions. In addition, scarring trees with a knife might a risk of injury to the hunters and a risk of transferring human smell to the tree, which an animal might find alarming and avoid.

A scent material might be used to lure animals downwind of the scent material. In an embodiment, the tree wrap can be used with the scent material for luring the animal to follow the scent and towards the tree warp the location desirable for the hunter.

According to some embodiments, the tree wrap can be portable, easy to carry, and is quick to install on a tree and remove from the tree. The tree wrap simulates an antlered rub and may be used in combination with a scent material to lure antlered animals. The tree wrap reduces the risk of injury to the hunter and prevents damage to a tree by a hunter trying to make a rub-like marking on a tree using a tool to lure antlered animals.

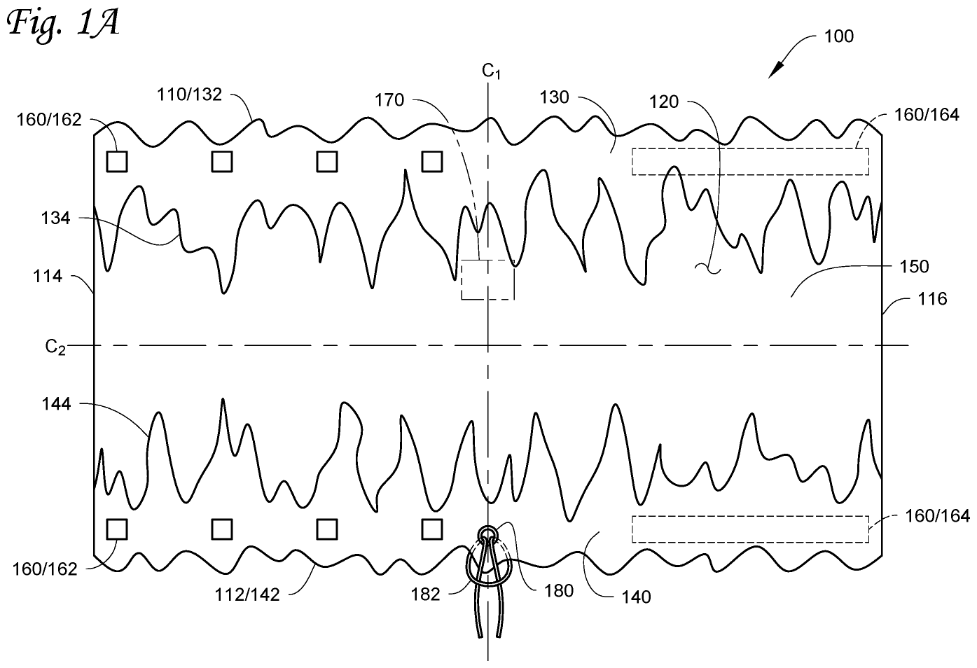

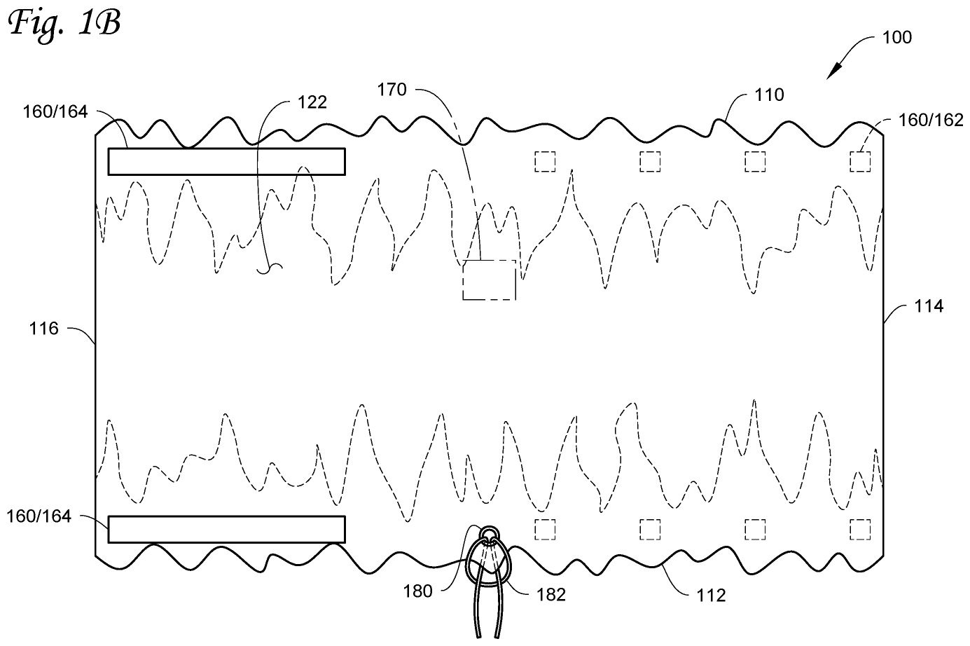

FIG. 1A shows a schematic front view of an embodiment of a tree wrap 100. FIG. 1A shows a front side 120 of the tree wrap 100. FIG. 1B shows a back view of the tree wrap 100, according to an embodiment. FIG. 1B shows a back side 122 of the tree wrap 100.

As shown in FIG. 1A, the tree wrap 100 includes an upper edge 110, a lower edge 112 opposite the upper edge, a first side edge 114, a second side edge 116 opposite the first side edge, the front side 120, and the back side 122. The tree wrap also includes an upper camouflage member 130 disposed at the upper edge 110 and a lower camouflage member 140 disposed at the lower edge 112. The upper camouflage member 130 and the lower camouflage member 140 are also each provided on the front side 120 of the tree wrap 100.

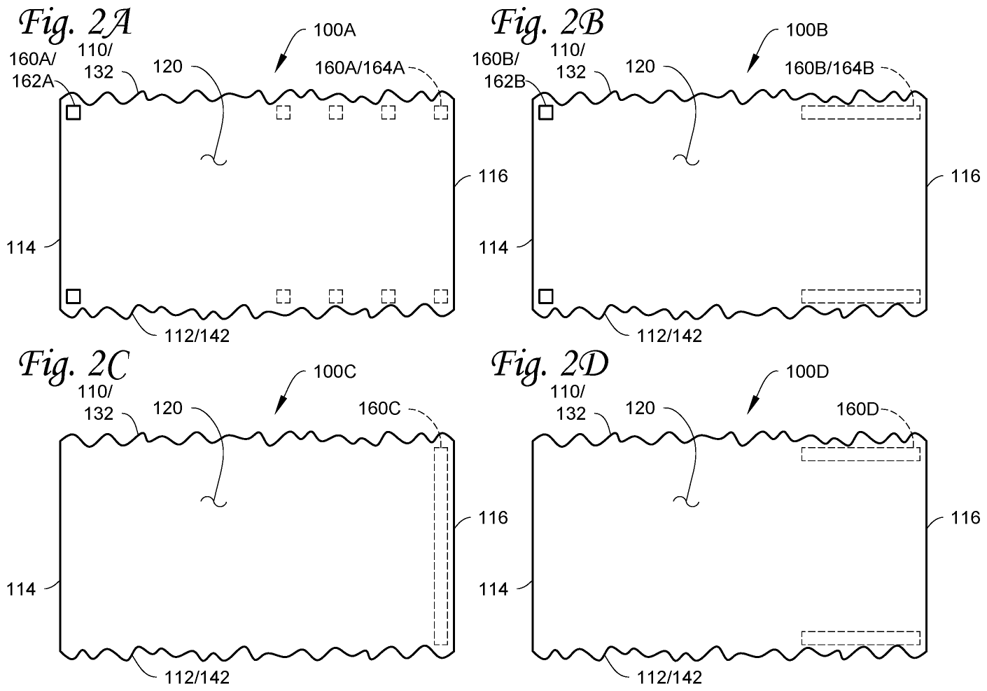

The tree wrap 100 further includes a mock rub member 150 and a fastener 160. The mock rub member 150 is disposed between the upper camouflage member 130 and the lower camouflage member 140, on the front side 120 of the tree wrap 100. The mock rub member 150 is configured to simulate an antler rub created by an animal scraping an antler against the tree. The fastener 160 is configured to attach the front side 120 to the back side 122 of the wrap such that the wrap may be fastened around a tree. In FIG. 2A, a vertical center line and a horizontal center line of the tree wrap 100 are indicated as C₁ and C₂, respectively.

The upper camouflage member 130 has an upper edge 132 that coincides with the upper edge 110 of the tree wrap 100 (e.g., the upper edge 132 of the upper camouflage member 130 is the upper edge 110 of the tree wrap 100). The upper camouflage member 130 has a lower edge 134 that is juxtaposed to the mock rub member 150 (e.g., side-by-side with, contacts). The lower camouflage member 140 has a lower edge 142 that coincides with the lower edge 112 of the tree wrap 100 (e.g., the lower edge 142 of the lower camouflage member 140 is the lower edge 112 of the tree wrap 100). The lower camouflage member 140 has an upper edge 144 that is juxtaposed to the mock rub member 150. As shown in FIG. 1A, the upper edge and the lower edge can be opposite edges in each of the camouflage members 130, 140

At least one of the upper camouflage member 130 and the lower camouflage member 140 may have a pattern simulating a tree bark and configured to blend into a texture of bark of a tree. In an embodiment, each of the upper camouflage member 130 and the lower camouflage member 140 may have a pattern (e.g., a similar pattern or different patterns) simulating a tree bark and configured to blend into a texture of bark of a tree.

The upper edge 132 of the upper camouflage member 130 and the lower edge 142 of the lower camouflage member 140 may be frayed and may form jagged lines. The jagged lines have protrusions and recessions in a planar direction of the camouflage members (e.g., protrusions and recesses that extend in the vertical direction, that extend in a direction along the centerline C₁). The sizing of the protrusions and recessions of the jagged line is not particularly limited (e.g., the protrusions and recessions having size(s) configured to blend with a tree bark). The upper edge 132 of the upper camouflage member and the lower edge 142 of the lower camouflage member may be made of a non-transparent, a transparent, or a semi-transparent material (e.g., a s mesh) so as to allow the patterns simulating a tree bark on the upper camouflage member 130 and the lower camouflage member 140 to naturally blend into the texture of a bark of a tree.

Each of the lower edge 134 of the upper camouflage member 130 and the upper edge 144 of the lower camouflage member 140 may have protrusions that extend into the mock rub member 150 and recessions that recede from the mock rub member 150 and create a jagged line. For example, the protrusions and recessions of each of the lower edge 134 and the upper edge 144 form a respective jagged boundary between the respective camouflage member 130, 140 and the mock rub member 150. The protrusions and recessions of lower edge 134 of the upper camouflage member 130 and the upper edge 144 of the lower camouflage member 140 may be of any suitable size that simulates an edge of a bark created by rubbing/scraping an antler of an antlered animal.

It is appreciated that the mock rub member 150 simulates an antler rub created by an animal rubbing/scraping its antler against a tree. Antlered animals are generally curious and/or territorial, and tend to approach and investigate unfamiliar antler rubs on a tree. Utilizing such behavior, a user can fasten the mock rub member 150 to tree at a location desirable to the user (e.g., for hunting). By including the upper camouflage member 130, the lower camouflage member 140 on the mock rub member 150, the tree wrap 100 can trick an antlered animal to approach and investigate the tree wrap 100, luring the antlered animals to the location desirable to the user.

As shown in an example of FIG. 1A, the fastener 160 is configured to securely attach the front side 120 and the back side 122 of the tree wrap 100 to each other (e.g., securely attached the front side 120 to the back side 122). With the fastener 160, the wrap 100 is securely fastened onto the trunk or a branch of a tree with the front side 120 of the wrap facing outside and the back side 122 facing the tree. It should be appreciated that the configuration of the fastener 160 is not limited to the embodiment shown.

FIGS. 2A-2D each illustrate an embodiment of a fastener 160A, 160B, 160C, 160D for a tree wrap 100A, 100B, 100C, 100D. As shown in FIGS. 1A, 1B and 2A-2D, the fastener 160, 160A, 160B, 160C, 160D may be affixed to the tree wrap 100 in different configurations. It should be appreciated the fastener may be affixed to the tree wrap 100 in a different configure than shown in the illustrated embodiments. As shown in FIGS. 1A, 1B, 2A, and 2B, the fastener 160, 160A, 160B can include a first side 162, 162A, 162B and a second side 164, 164A, 164B. In these embodiments, the first side 162 and the second side 164 are configured to securely attach to each other (e.g. a hook-and-loop fastener, or the like). The first side 162 is configured to securely and removably attach to the second side 164. For example, the first side 162 can be provided on one of the front side 120 and the back side 122, and the second side 162 provided on the other one of the first side 120 and the second side 122.

As shown in FIGS. 1A and 1B, the fastener 160 may have four pieces of first side 162 affixed on the front side 120 of the tree wrap 100 along each of the upper edge 110 and the lower edge 112 (e.g. four pieces disposed along the upper edge 110 and four pieces disposed along the lower edge 112). For example, the pieces of first side 162 are each closer to the first side edge 114 than to the second edge 116. The pieces of first side 162 are spaced apart from each other on the front side 120. The fastener 160 may also have an elongated piece of second side 164 affixed on the back side 122 of the tree wrap along each of the upper edge 110 and the lower edge 112 (e.g., a first elongated piece extending along the upper edge 110 and a second elongated piece extending along the lower edge 112). For example, the elongated pieces of second side 164 are each closer to the second side edge 116 than to the first edge 114. As shown in FIGS. 1A and 1B, the two elongated pieces of second side 164 each have a longer length than the pieces of first side 162.

As shown in FIG. 2A, the fastener 160A may have one piece of first side 162A affixed on the front side 120 of the tree wrap and four pieces each of second side 164A affixed on the back side 122 of the tree wrap 100A along each of the upper edge 110 and the lower edge 112. The four pieces of second side 164A being spaced apart from each on the back side 122.

As shown in FIG. 2B, the fastener 160B may have one piece of the first side 162B affixed on the front side 120 of the tree wrap 100B and one elongated piece of second side 164B affixed on the back side 122 of the tree wrap, along each of the upper edge 110 and the lower edge 112.

In FIGS. 2C and 2D, the fastener 160C, 160D is configured to attach directly to the material of the wrap 100C. In FIG. 2C, the fastener 160 is affixed along the second side edge 116 on the back side 122 of the wrap. In the illustrated embodiment, the fastener 160C only includes a single side (e.g., the material of the wrap 100C acting as a second side). In FIG. 2D, the fastener 160D includes an elongated piece disposed on the back side 122 of the wrap along each of the upper edge 110 and the lower edge 112 (e.g., a first piece disposed along the upper edge 110 and a second piece disposed along the lower edge 112). The pieces of the fastener 160D spaced apart from each other and are disposed closer to the second side edge 116 than to the first side edge 114.

The fastener may be a type that produces reduced noise when opening and closing the fastener. The fastener is not limited to a hook-and-loop fastener, and it should be appreciated that other suitable mechanisms that securely and removably attach the front side 120 and the back side 122 may be used.

In an embodiment, the tree wrap 100 may have a scent holder. The scent holder may include a scent pouch member (a scent pouch 170) and/or a grommet 180. The scent holder is affixed to the tree wrap and is configured to hold a scent material that releases animal scent. For example, the animal scent is a scent of the type being hunted (e.g., animal urine of the hunted animal, animal hormone(s) of the hunted animal, or the like).

As shown in FIGS. 1A and 1B, the scent pouch 170 may be attached to the front side 120 or the back side 122 of the wrap. The scent pouch 170 is configured to hold a scent material such as, but not limited to, scent pellet(s), scent bottle(s), and scent dispenser(s) that release the scent by diffusing the scent while the tree wrap is in use. The scent pouch 170 may be made of a material that absorbs scent materials (e.g. scent liquid, scent oil, etc.) and release the scent by diffusing the scent while the tree wrap is in use. It should be appreciated that the tree wrap 100 may include more than one scent pouch 170. The scent pouch may be placed on any location of the tree wrap 100 as long as it does not interfere with the tree wrap 100 simulating an antler rub on a tree.

As shown in FIGS. 1A and 1B, the scent holder may be a grommet 180 configured to receive an attachment member 182 (e.g., string, rope, ribbon, clip etc.) that holds a scent diffuser 184. FIGS. 1A and 1B show an example of a grommet placed at the lower edge 112 of the tree wrap. In an embodiment, the attachment member 182 may contain the scent (e.g., the scent applied to the material of the attachment member 182).

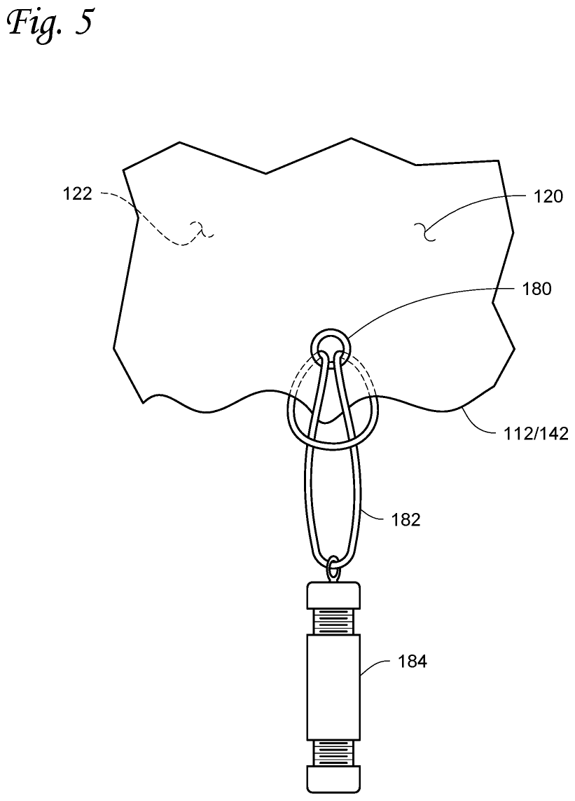

FIG. 5 shows an enlargement of the grommet 180 of FIG. 1A with an attachment member 182 and a scent diffuser 184. The grommet 180 penetrates the tree wrap 100 from the front side 120 to the back side 122. The grommet 180 can be made of a sturdy material to support the weight of the scent diffuser 184 without damaging the tree wrap 100. The location of the grommet is not limited to being along the lower edge 112, and the grommet may be placed anywhere on the wrap as long as it serves the purpose of holding a scent diffuser 184 and releasing scent while the tree wrap is in use. In other embodiments, the tree wrap 100 may include more than one grommet 180.

The tree wrap 100 is made of a material that is foldable by hand, flexible, stretchable, and/or the like. The material of the tree wrap 100 may be laid substantially flat as shown in FIGS. 1A and 1B. The material may be natural or synthetic fabric or plastic materials such as nylon and canvas cloth, but are not limited to these materials. In an embodiment, the material a tension fabric. In an embodiment, the material is polyester or a polyester blend. In an embodiment the material is wrinkle resistant. In an embodiment, the material is a sweat resistant fabric, which reduces the transfer of scent (e.g., in the form of sweat, oil, and/or smell) from human to the fabric upon user contact, such as handling and carrying of the tree wrap. In an embodiment, the material is preferably a low-noise material or a quite fabric that creates little to no noises when being handled (e.g. folding, unfolding, wrapping around a tree, and the material rubbing against each other etc.). For example, a low-noise material or the quite fabric makes substantially no noise when being unfolded and bent (e.g., when being wrapped around a tree).

The members 150 of tree wrap 100 may be formed using a single piece of foldable material or multiple pieces of foldable materials affixed to each other. In an embodiment, the upper camouflage member 130, the lower camouflage member 140, and the mock rub member 150 may be formed of a single piece of foldable material in which the patterns for the upper camouflage member 130, the lower camouflage member 140, and the mock rub member 150 on the single piece of foldable material. In another embodiment, the upper camouflage member 130, the lower camouflage member 140, and the mock rub member 150 may be prepared as separate pieces and attached together to make the tree wrap 100.

The tree wrap 100 may be any size that would be suitable to wrap around a tree trunk and simulate an antler rub. The flexible tree wrap may be configured for use with a specific kind of antlered animal or for a large variety of antlered animals. the tree wrap 100 is configured to form hollow cylindrical shape (e.g., circular shape, oval shape, or the like) that is adjustable to match a size of a tree in the above range. In one embodiment, the wrap may be configured for use in hunting multiple kinds of antlered animals (e.g., both whitetail deer and elk), in which the tree wrap 100 is able to form a hollow cylinder shape that is adjustable to match the circumference of any tree in the range of both kinds of animals. In another embodiment, the wrap may be configured for use in hunting just one type of antlered animal (e.g., whitetail deer), and the wrap 100 is able to form a hollow cylinder shape that is adjustable to match the circumference of any tree in the range of the one type of animal.

For example, the tree wrap 100 can have a width (e.g., measured parallel to C₂, extending from the first side edge 114 to the second side edge 116). In an embodiment, the width can be 12-24 inches. For example, the tree wrap 100 can have a height (e.g., measured parallel to C₁, extending from the upper edge 110 to the lower edge 112). In an embodiment, the height of the wrap can be 24 inches. It should be appreciated the width of the tree wrap 100 may be adjusted depending on the diameter of trees to be attached.

The tree wrap 100 may be provided with a carrying pouch for easy transport and storage and preventing undesired odor or material from transferring to the wrap. The tree wrap 100 may be provided in multi-packs to carry and use multiple units in lure hunting.

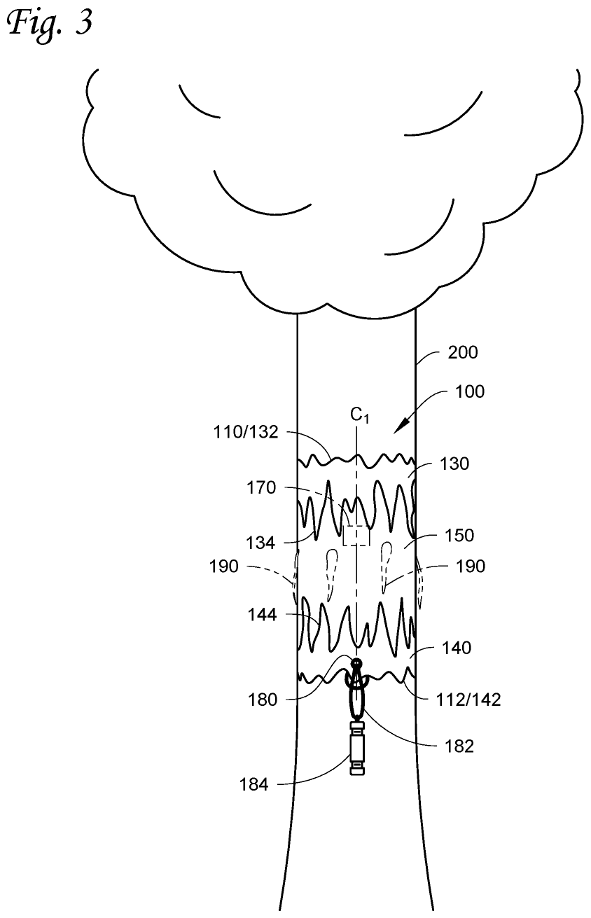

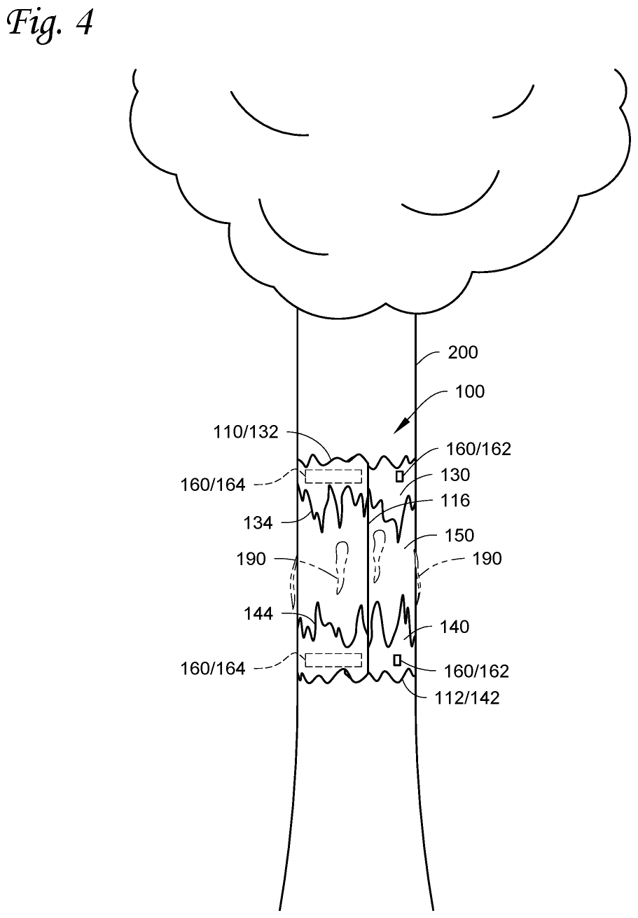

FIG. 3 shows an embodiment of the tree wrap 100 attached to a tree trunk 200, in which the vertical center line C₁ of the wrap faces the viewer. FIG. 4 shows an embodiment of a tree wrap 100 attached to a tree trunk 200, in which the first side edge 114 (not shown) and the second side edge 116 faces the viewer. For example, FIG. 3 is a front view of the tree trunk 200 and Figure is a rear view of the tree trunk 200. As shown in FIG. 4, the tree wrap 100 wraps around itself attached to the tree (e.g., when wrapped around the tree trunk 200). Each of side edges 114, 116 overlap with another portion of the tree wrap 100.

As shown in FIG. 3 and FIG. 4, the tree wrap 100 may have one or more hanging pieces 190 affixed on the front side 120 of the wrap 100. The hanging piece(s) 190 are configured to simulate a shredded tree bark or a piece of tree and to enhance the appearance of an antler rub when the tree wrap 100 is fastened on a tree. The number and material of the hanging piece is not limited, as long as the pieces serve the purpose of enhancing the appearance of an antler rub, and may be adjusted by the hunter.

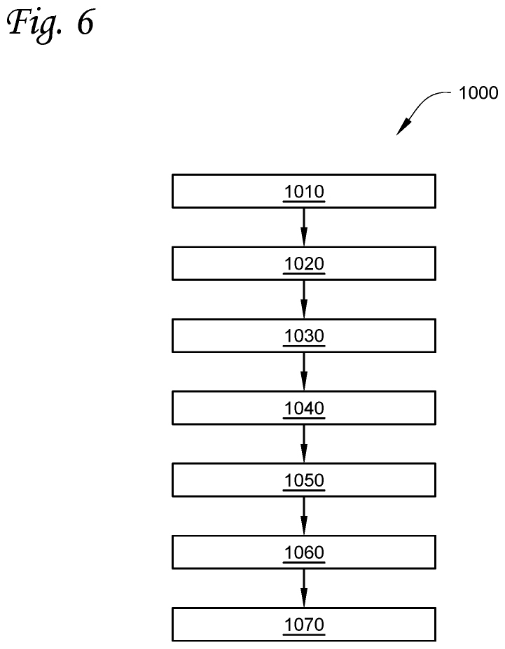

FIG. 6 is a block flow chart of an embodiment of a method 1000 of lure hunting an antlered animal using a tree wrap. The method includes fastening the tree wrap 100 onto a tree trunk 200 and blending with the tree as shown and described above according to some embodiments. For example, the method 1000 may use a tree wrap 100 as discussed above and shown in FIGS. 1A, 1B, 4 and 5.

The method 1000 starts at 1010. At 1010, a tree wrap (e.g., tree wrap 100, 100A, 100B, 100C, 100D) is positioned against a tree trunk (e.g., tree trunk 200) at a suitable height for an antler rub. The height is a height that the target antlered animal would make an antler rub. The height would be known to an ordinary hunter, and may be adjusted depending on the location, such as, but not limited to, the density of vegetation, direction the tree is growing, and/or the shape of the terrain the tree is located. The method 1000 then proceeds to 1020.

At 1020, the tree wrap is wrapped around the tree with a front side (e.g., front side 120) of the tree wrap facing outward and a back side (e.g., back side 122) of the tree wrap facing the tree. An upper edge (e.g., upper edge 110) of the tree wrap faces towards the top of the tree, and a lower edge (e.g., lower edge 112) faces towards the ground. The method 1000 then proceeds to 1030.

At 1030, the upper camouflage member 130 and the lower camouflage member 140 are blended with the bark of the tree. For example, the wrapping of the tree wrap around the tree at 1020 can result in the blending at 1030.

At 1040, the tree wrap is fastened onto the tree using a fastener (e.g., fastener 160) of the tree wrap. The fastening 1040 can include pressing a first side of the fastener (e.g., first side 162) to a second side of the fastener (e.g., second side 164), if the fastener has two sides. The fastening 1040 may include pressing the fastener 160 to the tree wrap 100, if the fastener has one side.

At 1050, a scent material is applied to a scent holder of the tree wrap. The scent holder used at 1050 may be a scent pouch (e.g., scent pouch 170) or a grommet (e.g., grommet 180). When the grommet is being used, the application of scent material at 1050 may include attaching a scent diffuser (e.g., scent diffuser 184) to the grommet via an attachment member (e.g., attachment member 182).

In an embodiment, 1010-1050 may be repeated when a hunter is employing multiple of the tree wraps. The method 1000 then proceeds to 1060.

At 1060, a hunter walks away from the tree wrap and waits for an antlered animal to approach the tree wrap lured by the visual signal from the tree wrap and/or the olfactory signal from the scent material. The method 1000 then proceeds to 1070.

At 1070, the tree wrap is removed from the tree by pulling the fastener and separating the front side and the back side of the wrap. The wrap is loosened from the tree and detached from the tree. The tree wrap can then be stored for transportation.

It should be appreciated that method of lure hunting an antlered animal may occur in a different order in the method 1000 (e.g. 1030 may occur after 1040 or 1050). It should be appreciated that the method 1000 in an embodiment may be modified to include features as shown and/or described for the tree wrap in FIGS. 1-6.

The terminology used in this Specification is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components. “Simulating” and “simulate” as used herein refers to making a feature look similar to, or indistinguishable from, the target feature to an eye of an antlered animal, such that the animal behaves as if the subject is a target feature. “Jagged” and “jagged line” as used herein refer to a line has protrusions and recessions and is not straight. “Blending” or “blend” as used herein refers to making a feature as if it is a part of the target subject or is continuous with the target subject to an eye of an antlered animal, such that the animal behaves as if the subject is a target subject.

With regard to the preceding description, it is to be understood that changes may be made in detail, especially in matters of the construction materials employed and the shape, size, and arrangement of parts without departing from the scope of the present disclosure. This Specification and the embodiments described are exemplary only, with the true scope and spirit of the disclosure being indicated by the claims that follow.

1. A tree wrap for being installed over a tree and luring an antlered animal, the tree wrap comprising:
an upper edge, a lower edge opposite the upper edge, a first side edge, and a second side edge opposite the first side edge;
a front side and a back side opposite to the front side;
an upper camouflage member disposed at the upper edge, on the front side of the tree wrap, the upper camouflage member is configured to blend with a bark of a tree;
a lower camouflage member disposed at the lower edge, on the front side of the tree wrap, the lower camouflage member configured to blend with the bark;
a mock rub member disposed on the front side between the upper camouflage member and the lower camouflage member, the mock rub member configured to simulate an antler rub created by an animal scraping an antler against the tree; and
a fastener configured to attach the front side to the back side for fastening the tree wrap around the tree.

2. The tree wrap of claim 1, wherein
at least one of the upper camouflage member and the lower camouflage member has a pattern simulating a tree bark.

3. The tree wrap of claim 1, wherein
at least one of the upper edge and the lower edge is frayed and has a jagged line for blending with texture of the bark.

4. The tree wrap of claim 1, wherein
the upper camouflage member has a lower edge juxtaposed to the mock rub member, and the lower camouflage member has an upper edge juxtaposed to the mock rub member, and
at least one of the lower edge of the upper camouflage member and the upper edge of the lower camouflage member has protrusions that extend into the mock rub member and recessions that recede from the mock rub member and create a jagged line.

5. The tree wrap of claim 1, wherein
the fastener is positioned on the tree wrap so as to adjustably fasten the tree wrap onto the tree, with the back side of the tree wrap facing the tree.

6. The tree wrap of claim 1, further comprising a scent holder disposed on the tree wrap.

7. The tree wrap of claim 6, wherein
the scent holder is a scent pouch member affixed to the tree wrap, wherein the scent pouch member is configured to hold a scent dispenser and diffuse scent.

8. The tree wrap of claim 6, wherein
the scent holder includes a grommet disposed on the tree wrap for receiving a string or a ribbon for hanging a scent dispenser.

9. The tree wrap of claim 6, wherein
the scent holder is disposed in at least one of the upper camouflage member and the lower camouflage member.

10. The tree wrap of claim 1, wherein
the fastener includes a hook-and-loop fastener.

11. The tree wrap of claim 1, wherein
the mock rub member is made of a polyester material.

12. The tree wrap of claim 1, wherein
the mock rub member is made of a foldable material.

13. The tree wrap of claim 1, wherein
the upper camouflage member, the lower camouflage member, and the mock rub member are made of fabric.

14. The tree wrap of claim 1, wherein
the mock rub member is made of a tension fabric.

15. The tree wrap of claim 13, wherein
the upper camouflage member, the lower camouflage member, and the mock rub member are separate pieces and are attached together.

16. A method for luring an antlered animal, the method comprising:
positioning a tree wrap against a tree;
wherein the tree wrap comprises:
an upper edge, a lower edge opposite the upper edge, a first side edge, a second side edge opposite the first side edge, a front side, and a back side opposite to the front side;
an upper camouflage member disposed at the upper edge, on the front side of the tree wrap,
a lower camouflage member disposed at the lower edge, on the front side of the tree wrap,
a mock rub member disposed on the front side between the upper camouflage member and the lower camouflage member, the mock rub member configured to simulate an antler rub created by an animal scraping an antler against the tree; and
a fastener configured to attach the front side to the back side;
blending at least one of the upper camouflage member and the lower camouflage member with a bark of the tree; and
fastening, via the fastener, the tree wrap to the tree.

17. The method for lure hunting of claim 16, further comprising applying a scent material to the tree wrap.

18. The method for lure hunting of claim 16, further comprising loosening the fastener to remove the wrap from the tree.

19. The method for lure hunting of claim 16, wherein
the fastener is affixed on the front side or the back side of the wrap, and
the method further comprises fastening by pressing the fastener to the wrap.

20. The method for lure hunting of claim 16, wherein
the positioning the tree wrap against the tree is positioned at a height suitable for the antler rub created by the animal scraping the antler against the tree.
